(19) United States
(12) Patent Application Publication
(10) Pub. No.: US 2010/0235356 A1
(43) Pub. Date: Sep. 16, 2010

(54) ORGANIZATION OF SPATIAL SENSOR DATA

(75) Inventors: Yonatan Wexler, Redmond, WA (US); Eyal Ofek, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/401,481

(22) Filed: Mar. 10, 2009

(51) Int. Cl. G06F 17/30

(52) U.S. Cl. 707/737; 707/E17.031; 707/769

(57) ABSTRACT

A measurement of an object from which data is collected may be determined. A scale of the object may be determined by determining the absolute or relative magnitude of the object in comparison to a magnitude of surrounding objects such as the total magnitude of the illustration. An appropriate container shape and size for the object may be determined by searching for a container size with a scale similar to the scale of the object. The object may be stored in a database with the appropriate container shape, size and the scale being attributes.

### BACKGROUND

This Background is intended to provide the basic context of this patent application and it is not intended to describe a specific problem to be solved.

Queries to find objects in photo or illustrations can return a wide variety of results. Often, the results are somewhat related but are not exactly what the user seeks. A user often has to sort through photos and illustrations manually to locate the desire object in the desired size at the desired resolution. Related, the storage of photos of objects is just as jumbled as what may seem related by a title is not related by the content of the photo or illustration.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of organizing sensor data in a database is disclosed. In some examples, the sensor may be an a photo, a radar reading or audio measurement. If an object is detected in the measurement then it may be represented, otherwise the whole measurement may be used as “the object”. A measurement of an object from which data is collected may be determined or captured along with the measurement. The “image” is a general definition to describe captured data. It may be an image, a radar, a LIDAR scan, a depth camera capture, a sonar image, etc. A scale of the object may be determined by the magnitude of the object in comparison to a magnitude of surrounding objects such as the total magnitude of the illustration. An appropriate container size for the object may be determined by searching for a container size with shape and scale similar to the shape and scale of the object. The object may be stored in a database along with the appropriate container size and the scale being attributes. Queries to the database may be entertained using the container shape and/or the scale as the attribute to be searched.

### BRIEF DESCRIPTION OF THE DRAWINGS

FIG. 1 is an illustration of a portable computing device;

FIG. 2 is an illustration of a method of arranging object data in a database with relevant attributes;

FIG. 3 is an illustration of objects in a photo with different scale;

FIG. 4 is an illustration of determining a footprint of an object;

FIG. 5 is an illustration of determining a three dimensional footprint of an object; and

FIG. 6 is an illustration of a query rectangle intersecting object footprints.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

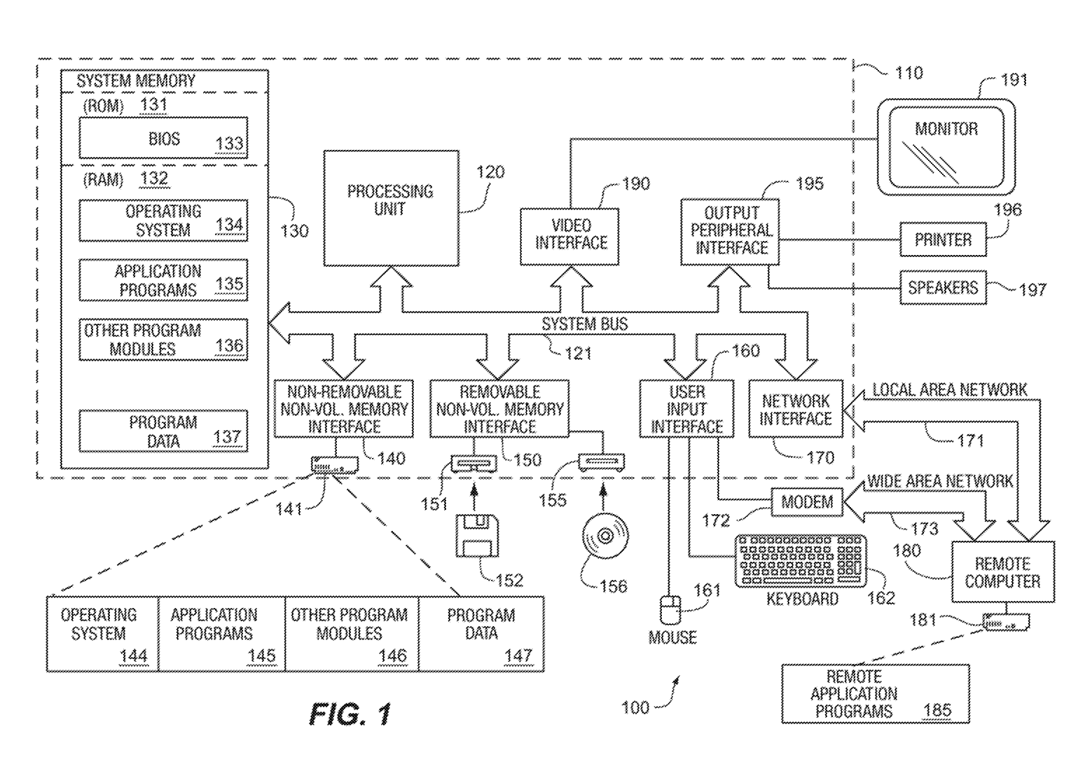

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

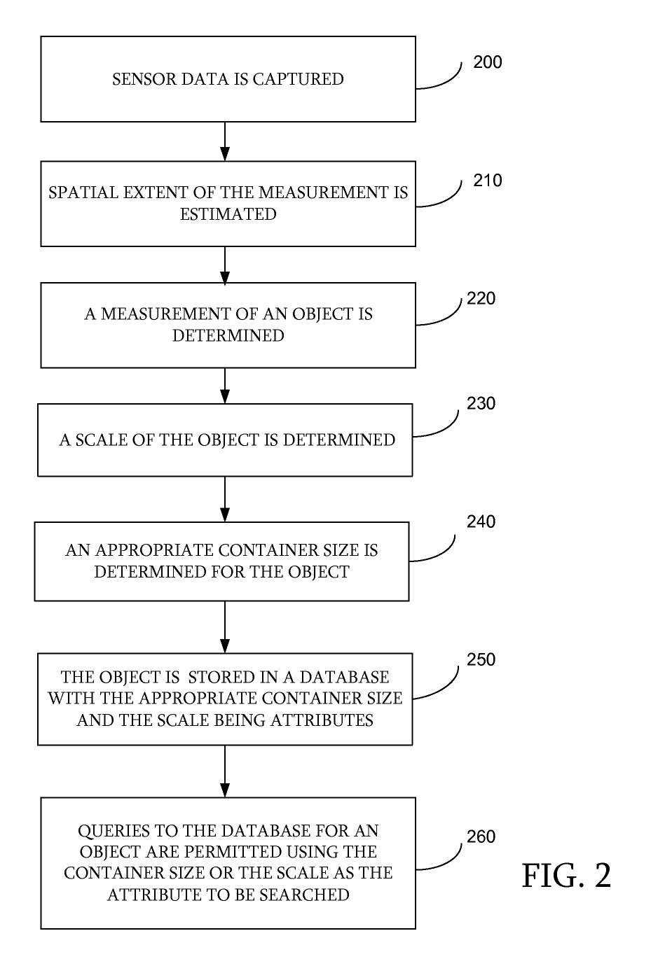

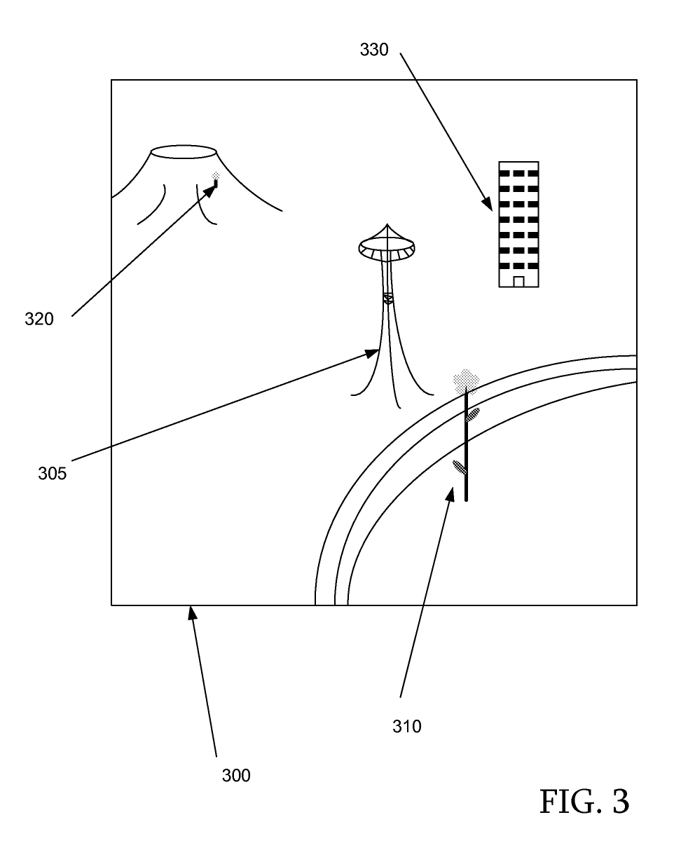

FIG. 2 illustrates a method of organizing data in a database. At a high level, the method associates with each measured data its spatial extent. The spatial extent of the measurement may be different from the spatial location of the sensor. For example, when taking a picture, the location of the camera is different than the location of the content of the image. The scale of the estimated measurement may be used for hierarchical organization of the data. A query for large scale data need not involve smaller details. For example, when a user specifies the American continent as the query extent, the user is probably looking for aerial/space image, and not a photo taken from inside a bakery in New-York. In addition, the desire may be for an object of a particular size and rarely will the size of the object be noted in a title. As an example, a user may desire a photo of a flower. Referring to FIG. 3, in the photo 300, there may be two flowers 310, 320 in the photo 300, such as the flower 310 on the ledge overlooking Seattle and the flower 320 in the distance on Mount Rainer. The flower 320 on Mount Rainer is so small that it is of extremely little use. However, a search for a flower may return such a picture, such as a satellite photo of Mount Rainer that shows flower 320.

At block 200, sensor data is captured. The sensor data may be a focal length, a GPS position of a camera, a sound pressure reading, an altitude, etc, The sensor data may provide a general area related to the measurement taken. For example, for a photo, the sensor data may provide a general location of the photograph. For a sound reading, the sensor data may be an initial sound pressure reading. For sensors that contain multiple measurements (such as cameras that comprise of many separate pixels, audio that comprises of many different time samples, LIDAR data that comprises of many different laser directions) one actual measurement can be broken into several meaningful parts. Of course, other sensor data is possible and is contemplated.

At block 210, a spatial extent of the measurement is estimated. In a database, there may be many measurements of the environment illustrated in FIG. 3. Some environments may contain the whole scene, some may contain close-up details. The knowledge of the spatial extent of measurements may be used for a more efficient storage. Large extents can be stored separately from small ones. At query time, the size of the user's request can be used to search in the proper size in the database. This way, query 410 may return a measurement containing mostly the space needle 305, even if there is another measurement containing the whole scene (with 310,320,330). A more useful way to store objects such as 305 (the Space Needle or the flower 310 or the flower 320, all of which will be considered objects 305) may be by size or relative size to their environment. For example, a photo 300 with just the flower 310 may be a much more useful result than a photo 300 with just the flower 320. Accordingly, the method attempts to classify measurements by size and allows searches to be made using size or relative size as a search criteria. The object 305 may be an object 305 in a photo, such as a building, a structure, a flower, etc. However, the object 305 also may also be directional sound. temperature, or pressure where the difference between an object 305 and the surrounding objects may be determined.

The description of the shape may be induced by the reference query space. Appropriate shape primitive to describe parts of this space may be used in the system. For example, when organizing photographs from an outdoor trip, the space may comprise of a two dimensional map, parallel to the ground. Shapes in this space may be two dimensional rectangles or other types of polygons. When organizing photos of a rock climbing competition, the map may be the two-dimensional plane parallel to the wall. When organizing astronomical measurements, the domain may be a representation of outer space which may be three-dimensional. When the measurement is a temperature, the shape can be a one dimensional interval. Here, the shape is also referred as ‘footprint’.

In some embodiments, if parts are detected in the measurements, these are analyzed as well. When parts are identified inside the measurement (such as elements inside a photograph) these parts may be treated as independent measurements. In such embodiment, pats of a measurement may be treated as independent or derived entities in the system. In such embodiment, a measurement is taken, objects within the measurement are recognized and analyzed. Their spatial extent is then measured or estimated, and are stored in the system. In the following, we refer both to complete measurements and to sub parts of it as ‘object’.

At block 220, a measurement of an object 305 from which data is collected may be determined. As mentioned previously, the object 305 may be an item in a photo such as in FIG. 3. The measurement may be determined in a variety of ways. In some embodiments, applications such as Visual Earth™ from Microsoft® may be used as these applications have a scale included and this scale may be used to estimate measurements. In another embodiment, calculations are made using a focal length of a photo and the size of the object in the photo determine the measurement of the object 305. In yet a further embodiment, the photo is searched for additional objects 310 320 where the measurements are known. The object 305 is then compared to the additional objects 310 320 to determine a measurement estimation. Of course, other methods of estimating or determining measurements are possible and are contemplated.

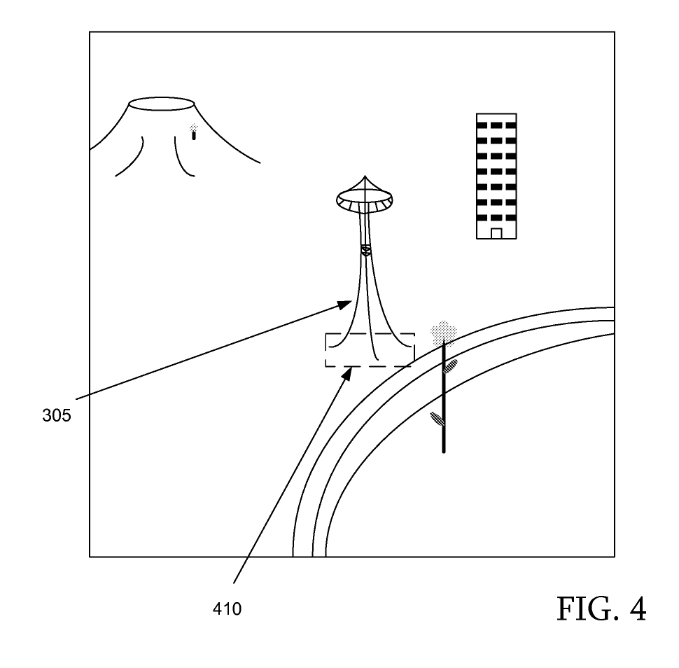

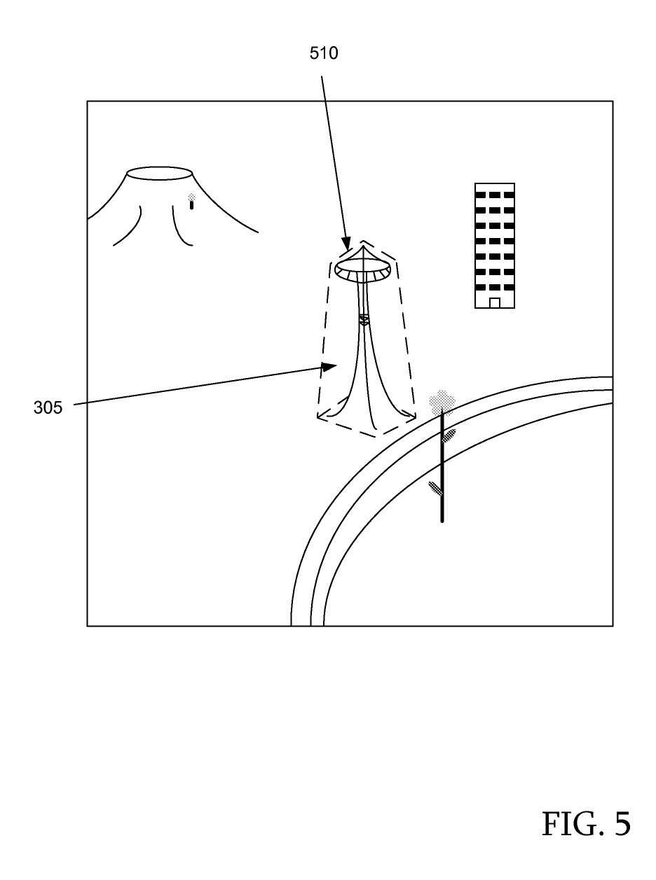

In one embodiment, the measurement is a footprint measurement or size of the object. FIG. 4 may illustrate a footprint measurement 410 of the object 305, specifically the Space Needle. A footprint 410 may simply be a rectangle that encloses where the building meets the ground. Such a rectangle may make searches easier but assume that searched will be based at ground level, not at different altitudes. In another embodiment, the footprint 410 is in three dimensions. In another embodiment, the footprint 410 may be a bounding box around the perimeter of the object 305, specifically, the Space Needle. In yet another embodiment, the footprint 410 is a polygon and in a further embodiment, the footprint 410 is a circle. FIG. 5 illustrate a three dimensional 510 footprint 410 around the Space Needle. Using the three dimensional footprint 510, searches at different altitudes may be possible.

In another embodiment, the coordinates of latitude and longitudinal lengths of each object 305 are calculated and a bounding box is created where the bounding box has the minimum and maximum longitude and a minimum and maximum latitude. The latitude and longitude may be determined using a LIDAR device, a LIDAR camera or from known latitude and longitude coordinates. The resulting bounding boxes may then be associated with an object 305 and the bounding box and object 305 may be stored in the database. Of course, other manners and methods of creating a footprint 410 are possible and are contemplated.

In one embodiment, the measurement is a footprint measurement or size of the image. An image is retrieved if the search point of interest falls within it's foot print (that is the object is visible in the image). The relative position of the object in the footprint determines the distance of the object from the camera, and may be used to estimate the object size in the image (thus, it's relevance for this query). The foot print can be calculated using the image parameters (camera's position, orientation and internal parameters such as the focal length or view angle), and some representation of the scene geometry to estimate the visibility. The geometry may be given by LIDAR scanning, stereo reconstruction, existing 3D models (such as Virtual Earth 3D), a digital terrain model, or just by approximating the scene by some simple geometry, such as a ground plane.

At block 230, a scale of the object 305 may be determined. The scale may be determined in several ways. In one embodiment, a scale is created by determining a magnitude of the object 305 in comparison to a magnitude of surrounding objects 310 320. For example in FIG. 3, if the height of office building 330 is known and the office building 330 is sufficiently close to the object and the view of the photo is not overly angled, the height of the object 305 may be estimated in comparison to the known building 330.

In another embodiment, the scale of the object 305 is determined by comparing the magnitude of the object 305 with the magnitude of the photo 300. In this way, the percentage of the photo 300 that is devoted to the object 305 may be determined. For example, the flower 320 may be 1% of the photo 300 while the flower 310 may be 10% of the photo 300.

In yet another embodiment, the measurements from block 220 are used to determine the area of the object 305 in comparison to the area of the photo 300. For example, the base of the object 305 (the Space Needle) is known to be 100 feet and the base takes up ten percent of the horizontal distance across the photo 300, the entire photo 300 length may be estimated as being 1,000 feet (100 feet/10%).

In another embodiment, objects 305 are automatically recognizing and the measurement and/or location of the recognized objects 305 may be used estimate the scale of the objects 305. For example, a databases of photos with pre-identified objects 305, including the size and location of the objects 305, may be used to identify and estimate the location of the objects 305 in front of the camera. One such application is Virtual Earth™ from Microsoft®. Of course, other methods and approaches to determining the scale are possible and are contemplated.

At block 240, an appropriate container size may be determined for the object 305. The determination may comprise searching for a container size with a scale similar to the scale of the object 305. For example, some containers may contain photos where the object 305 is less than 5% of the photo. Some container may contain photos where the object 305 is more than 5% of the photo but less than 25% of the photo. Yet another set may contain objects 305 that are more than 25% but less than 50% of the photo. Finally, another container may contain photos where the object 305 is more than 50% of the photo. As can be imagined, this additional attribute of scale may be of great benefit when searching for appropriate photos.

At block 250, the object 305 may be stored in a database with the appropriate container size and the scale being attributes. Other attributes also may be added to the database. For example, an additional attribute may be a description of the object 305 in the photo. In this way a search for “Space Needle” and “scale>50%” would likely result in a small number of very targeted photos.

In another embodiment, the description is used to determine a classification for the object 305. For example, the Space Needle may be classified as a “Building with a view,” a “Restaurant,” “Open to the public” but would not be classified as “Golf Course.” In this way, if the name of the restaurant is forgotten, a search for “restaurant” and “scale<25%” would return more targeted results.

Another attribute that may be useful to add to the database is a view direction attribute. For example, a search may be created for the object 320 Mount Rainier. Viewing the object Mount Rainier 320 from Seattle is different than viewing the object 320 Mount Rainier 320 from Portland. By adding a view direction, such as “looking east”, “from the west”, etc., an even better match may be made in searching for a photo.

It also may be useful to add an attribute regarding whether the object 305 is visible in the photo. While using a two dimensional model, in dense cities, some objects 305 may be not be seen from a photo from certain angles. However, a two dimensional outline may indicate that the object 305 would be visible. By marking whether the object 305 is truly visible in the photo, better results may be created.

In some embodiments, the object 305 may have a scale, a footprint, a classification, a description and a direction. These attributes (scale, a footprint, a classification, a description and a direction) may be stored as metadata to the object 305 or as attributes in a database.

At block 260, queries to the database for an object 305 may be permitted using the container size or the scale as the attribute to be searched. Other attributes also may be used to refine the object 305 search such as description, classification, matching polygons, matching bounding boxes, etc.

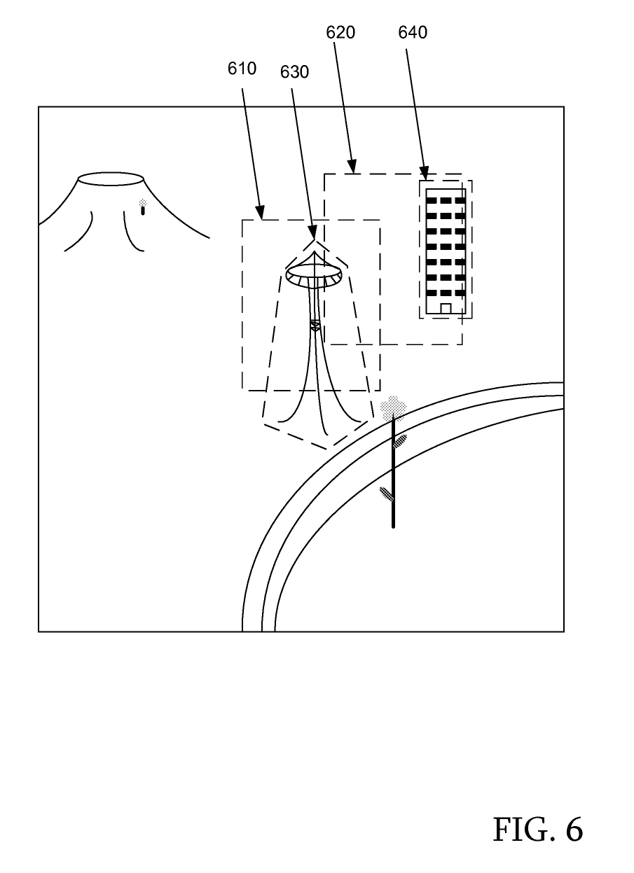

In another embodiment, a query may be expressed as a rectangle. FIG. 6 illustrates query rectangles 610 and 620. Of course, the query rectangle 610 and 620 may be any shape such as a circle, a triangle, a square, etc. If a bounded box of an object 305 falls within or intersects the query rectangle 610 620, the object may be returned as a match. For example, query rectangle 610 intersects the bounded box of object 630 meaning object 630 would be returned. Query rectangle 620 may intersect both bounded boxes of object 630 and 640 so both objects may be returned in response to the query.

In action, the results of the attribute of scale may result in better query results. Better query results saves processor time, user time, memory, electricity, reduces user frustration and increases user satisfaction. In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of organizing data about an object in a database comprising:
determining a measurement of the object from which data is collected
determining a scale of the object comprising:
determining an object magnitude in comparison to a surrounding object magnitude;
determining an appropriate container shape and size for the object comprising:
searching for a container size with a scale similar to the scale of the object;
storing the object in the database with the appropriate container shape, size and the scale being an attribute of the object;
allowing queries to the database using the container size or the scale as the attribute to be searched.

2. The method of claim 1, wherein the object is an item in a photo, wherein the measurement of the object in the photo is determined and wherein the measurement of the object is a footprint of the object.

3. The method of claim 2, further classifying the scale of the object in comparison to a magnitude of the photo.

4. The method of claim 2, wherein the footprint is in three dimensions.

5. The method of claim 2, wherein the footprint at least one selected from a group comprising:
a bounding box; and
a polygon.

6. The method of claim 1, further comprising automatically recognizing and estimating a location of the objects in front of a camera.

7. The method of claim 2, wherein an additional attribute is a description of the object in the photo and wherein the description is used to determine a classification for organizing the data.

8. The method of claim 1, further comprising using databases of photos to identify and estimate a location of the objects in front of a camera.

9. The method of claim 1, further comprising searching for all objects of a similar scale with a similar description in a similar classification.

10. The method of claim 2, further comprising searching for matching polygons in the database of stored objects.

11. The method of claim 1, further comprising querying for a scale attribute and returning only footprints that meet the scale attribute.

12. The method of claim 1, further comprising given a query footprint, returning all footprints that intersect the query.

13. The method of claim 1, further comprising:
calculating coordinates as latitude and longitudinal lengths of each object;
creating a bounding box where the bounding box comprises a minimum and maximum longitude and a minimum and maximum latitude;
associating the bounding box with the object;
storing the bounding box and the object in the database.

14. The method of claim 1, further comprising adding to the object at least one selected from a group comprising:
a view direction attribute to the object;
an attribute to indicate whether the object is visible;
an attribute of whether the object has the scale;
a footprint of the object;
a classification of the object;
a description of the object; and
a direction of the object.

15. The method of claim 14, wherein the scale, the footprint, the classification, the description and the direction are stored as metadata to the object.

16. The method of claim 1, wherein the object comprises one selected from a group comprising directional sound. temperature, pressure.

17. A computer system comprising a memory physically configured in accordance with computer executable instructions for organizing data about an object in a database, a memory physically configured in accordance with the computer executable instructions and an input/output circuit, the computer executable instructions further comprising instructions for:
determining a measurement of the object from which data is collected;
determining a scale of the object comprising;
determining an object magnitude in comparison to a surrounding object magnitude;
classifying the scale of the object in comparison to a magnitude of the surrounding objects;
determining an appropriate container shape and size for the object comprising:
searching for a container size with a scale similar to the scale of the object;
storing the object in the database with the appropriate container shape, size and the scale being an attribute of the object;
allowing queries to the database using the container size or the scale as the attribute to be searched.

18. The computer system of claim 17, wherein the object is an item in a photo, wherein the measurement of the object in the photo is determined and wherein the measurement of the object is a footprint of the object.

19. The computer system of claim 17, further comprising
calculating coordinates as latitude and longitudinal lengths of each object;
creating a bounding box where the bounding box comprises a minimum and maximum longitude and a minimum and maximum latitude;
associating the bounding box with the object;
storing the bounding box and the object in the database.

20. The computer system of claim 17, further comprising adding to the object at least one selected from a group comprising:
a view direction attribute to the object;
an attribute to indicate whether the object is visible;
an attribute of whether the object has the scale;
a footprint of the object;
a classification of the object;
a description of the object wherein the description is used to determine a classification for organizing the data; and
a direction of the object.
